(19) United States
(12) Patent Application Publication
(10) Pub. No.: US 2019/0095187 A1
(43) Pub. Date: Mar. 28, 2019

(54) INCREMENTAL UPDATES IN STATIC LIBRARIES

(71) Applicant: Trillium Incorporated, Nagoya-Shi (JP)

(72) Inventors: Aaron Sanjaya Benedek, Tokyo (JP); Samir Kumar Mishra, Kanagawa (JP)

(21) Appl. No.: 15/719,053

(22) Filed: Sep. 28, 2017

(51) Int. Cl. G06F 9/445; G06F 12/10; H04L 29/06

(52) U.S. Cl. CPC G06F 8/65; G06F 12/10; G06F 2212/657; G06F 2212/1041; H04L 63/0428

(57) ABSTRACT

A limited memory system uses statically linked code from different entities, with each entity having a fixed code space. Entry points for each code space are located at a fixed external address and referenced to a jump address inside each code space. Dummy code containing relevant entry point addresses is used to simulate the code of other entities for compilation and linking. Each entity is able to update its own code without the need for source code from the other entities that would typically be required in traditional statically-linked code.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Performing updates to applications has been done for generations of electronic devices, from operating systems to programs such as word processors. In systems with large memory spaces, such as desktop computers and even smart phones, compiled programs are combined with callable routines in a process called linking. These linked libraries are physically included in the base program and are callable without external references. This process is known as static linking and provides the advantage of having all the code necessary for execution of the application in one file or executable. Because all the program code and included libraries are present in the executable code, the code is virtually guaranteed to have all the routines necessary to execute.

However, statically linked code can be large. When downloading an update of such an application, there must be enough memory space to accommodate both the existing program (should a rollback be necessary) as well as the updated program. In memory confined applications, such as controllers used in embedded systems, having free space equal to the largest program simply to support future updates may be neither practical nor cost effective. Also, whereas desktop and smartphones most often have high speed networks available, some controller applications may have relatively slow bus and network access speeds significantly impacting system resources and update speeds. Further, when an update to either the base application or any of the statically linked libraries is needed, for example to improve security, the source code for the base program and all the associated libraries must be available for the compiling and linking processes.

An alternative to static linking is called dynamic linking. In this case, a base program may include references to external programs and routines, often called dynamically linked libraries (DLLs). In this scenario, the external routines or libraries are not incorporated until the base program is actually executed, using a process called late binding. In this scenario, an instance of the library code is bound to the executable at runtime. The use of DLLs allows base programs to be smaller because many common functions are shared among other programs. DLLs also allow independent updates to the base code and the DLLs without the need for each program and library's complete source code. However, if a change to either the base code or one of the DLLs causes the nature of its operation to change so that a library returns unexpected values or does not support previously available features, the executable code may become inoperable in a scenario known as “DLL hell.” Dynamically linked code may also require more memory as each instance of a DLL may need its own memory space at runtime. This is not typically a problem in large memory devices, such as a desktop, but as discussed above, in some environments, memory space is limited.

### SUMMARY

A process for compiling application programs uses a combination of static and dynamic linking to address the shortfalls associated with each described above. A memory of a controller may be divided into pre-assigned memory spaces or partitions for applications and libraries that may be from different vendors. Each memory space includes a virtual mapping table that provides an abstraction to actual entry points into the code for that one memory space.

Each application or library provider can update its code and internal entry points independently of the applications in other partitions because the virtual mapping table allows modules executing from each partition to have static links to other modules while each module may use a jump table to direct execution from its published entry point to its actual entry point.

In addition, this level of independence allows granular code updates at the binary level down to the replacement of a single byte of code, saving time and preserving both memory and network resources.

### BRIEF DESCRIPTION OF THE DRAWINGS

The figures depict a preferred embodiment for purposes of illustration only. One skilled in the art may readily recognize from the following discussion that alternative embodiments of the structures and methods illustrated herein may be employed without departing from the principles described herein.

FIG. 1 is a block diagram of a system supporting incremental application updates in accordance with the current disclosure;

FIG. 2 is an illustration of an exemplary portion of system memory of an ECU from FIG. 1;

FIG. 3 is an illustration of an exemplary source code set used in updating an application in the memory of FIG. 2; and

FIG. 4 is a block diagram of a package builder;

FIG. 5 is a flowchart of a method of performing an application update in accordance with the current disclosure.

### DETAILED DESCRIPTION

Most computers and even handheld devices have relatively large memory models and have the luxury of sufficient memory space to download an entire updated application before deleting the existing version. However, memory-constrained devices, such as automotive controllers including engine, transmission, and body controllers typically are memory constrained for both economic and design reasons. Further, such controllers may be connected by fault and noise tolerant networks that operate at much slower speeds than a typical Ethernet or WiFi connection. Lastly, the operation of such a controller may be life safety critical, requiring the highest levels of assurance that all functions work correctly and fail safely.

Static linking of compiled executable code has been a standard of programming since the early days of compiled programs. As discussed above, static linking helps to ensure that all modules required for code execution are present and compatible with the base executable code. However, in prior art scenarios static linking requires access to the source code for each module and all libraries represented in the final executable code object. In a controller environment, the contributors to each executable module may be from different operations, such as engine electronics and body electronics or may even be from different companies entirely, acting as subcontractors or simply as vendors of products. In these cases, there may be technical reasons, business reasons, or both, that may make access to all the source code difficult. One technical reason may simply be the difficulty of managing source code versioning across even internal organizations in a company. The code release cycle may involve many layers of development, testing, and quality checks. On top of that, bug fixes or special releases can further add to the complexity of maintaining a stable code platform that is sharable among different development groups. In some cases, differences in the development environment such as release level of the compiler can affect the code output. For these technical reasons, sharing source code among different groups can be a challenge.

Beyond the technical reasons, the business reasons for not sharing code can dwarf the technical reasons. There are two primary difficulties when sharing source code among organizations. When one organization shares it's source code with another, even among internal divisions of the same company, they must trust that the recipient will not make changes to the code before compiling. Even inadvertently altered code can raise issues of liability and even negligence if damage or injury result from broken code modules. Perhaps even beyond that, the source code for a module embodies the intellectual property associated with the operation of the module and most if not all of the operational traits of the mechanical equipment being controlled. For many entities, one or both of these business reasons make sharing source code for the purpose of statically linking code virtually undesirable at best.

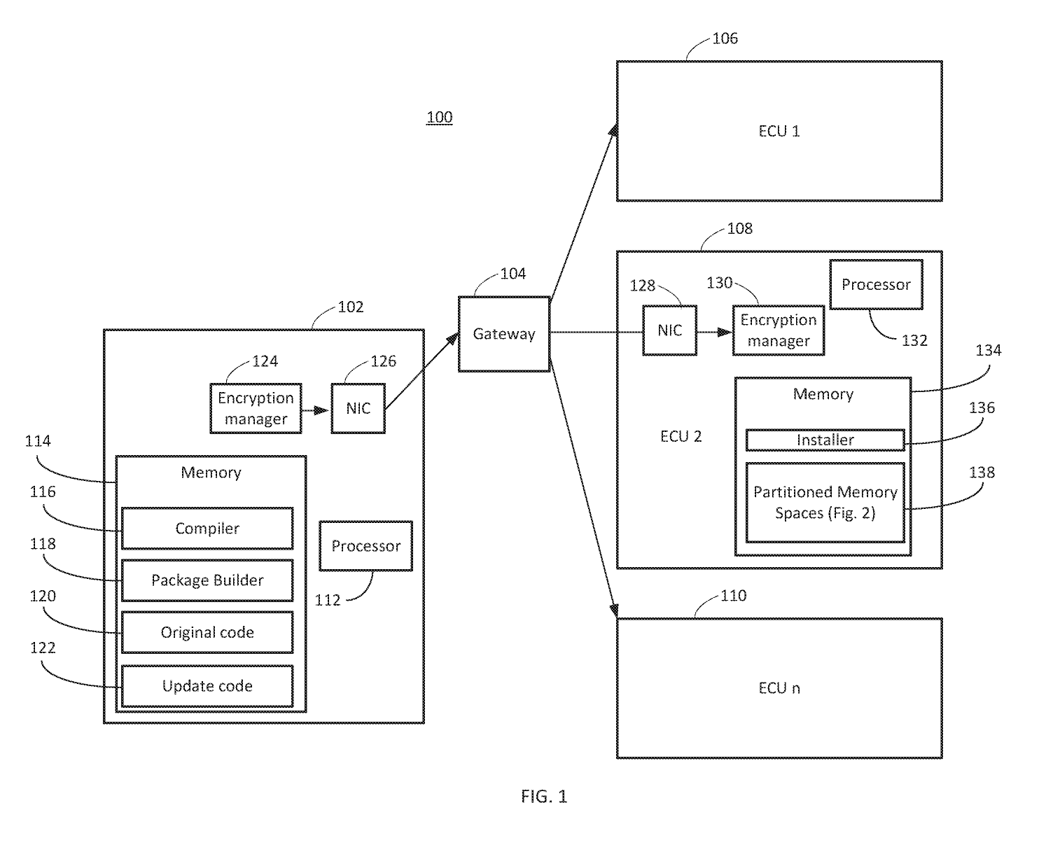

FIG. 1 illustrates a system 100 for generating and installing statically linked code with dynamic references. In this illustrated embodiment, a development computer 102 may be linked by a gateway 104 to a number of similarly-configured electronic control units (ECUs) 106, 108, 110. The development computer 102 may be a single computer or may be a networked computer, cloud-based environment, hosted service, or other implementation supporting software development including code management, compilation, linking and transport of code to the ECUs 106, 108, 110.

In the environment discussed above, where code executing on the ECUs 106, 108, 110 may be from different development teams or even different companies, the development computer 102 may be associated with only one of the teams responsible for code operating in one or more partitions of an ECU memory, as discussed more below. In this case, there may be multiple development computers (not depicted), each coupled to the gateway 104 and responsible for code in separate partitions of the ECUs 106, 108, 110. The description of the development computer 102 is representative of other such development environments.

The development computer 102 may include a processor 112 and memory 114. The processor 112 may be a conventional single or multiple core processor such as those available from Intel or AMD. The memory 114 may be any combination of physical storage devices including static and dynamic RAM, flash memory, rotating media, etc. The memory 114 does not include carrier wave or propagated media-type memories.

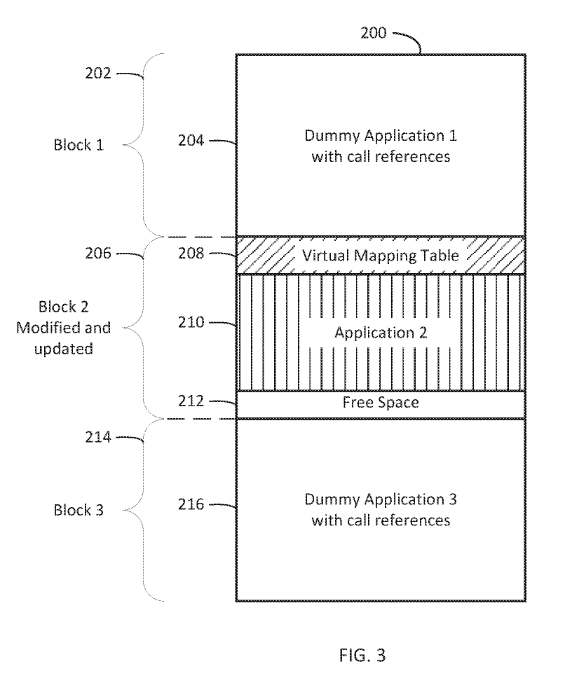

The memory 114 may include a number of modules including a compiler 116 and a package builder 118. The package builder 118 is discussed more below with respect to FIG. 3. In addition, the memory 114 may include data such as an original version 120 of code for a partition and code 122 representing an update to that module. In some embodiments, the “before” code 120 and “after” code 122 may be used to generate a difference file that is ultimately used for incremental updates at the ECUs 106, 108, 110.

For the sake of simplicity, only the compiler 116 is illustrated but it may be understood that the compiler 116 may include other development environment elements such as a linker. The compiler 116 may also be associated with other development tools such as a source code management system, testing tools, libraries, etc. Numerous integrated development environments (IDEs) for real time code development are commercially available from companies such as PragmaDev and IAR Systems. The compiler 116 (and related suite of tools if used) may be a commercially available product or, in some cases, may be a modified system for use in a custom development environment. The compiler 116 may support any number of languages used to develop the code of the controller, including C and C++, or others. In some extremely limited memory environments, or when fast loop execution is required, coding of some routines may still be done in assembler language. In this case, the code entry points may be set by hand, rather than by a linker. Whether coded in a high level language that is compiled and linked, or coded in assembler language, the description below for management of statically linked code applies equally.

The development computer 102 may also include an encryption manager 124 that is responsible for encryption of updated code to be delivered to the ECUs 106, 108, 110. In another embodiment, the encryption of the updated code may be handled by a gateway 104. The details of the cryptographic processes associated with encryption algorithms, key management, key distribution, etc., are beyond the scope of this disclosure. A network interface controller (NIC) 126 may manage physical communication with downstream components, handling such things as protocol-related handshaking, error corrections, delivery confirmations, etc.

Continuing the descriptions of FIG. 1, the gateway 104 may serve as a management point for sending changes to the individual ECUs 106, 108, 110. While the code developers working at the development computer 102 may know what code is required for a particular make and model of ECU, those code developers may not know what actual products have that make and model. The gateway 104 may serve as the manufacturer's or distributor's control point for determining which units require an update with the particular code in question. The gateway 104 may also manage the actual download process, ensuring confirmed delivery, and possibly confirmed installation of code updates at the individual ECUs 106, 108, 110. When used for this role, the gateway 104 may also include a database for management of delivery and installation confirmations, for example, for warranty purposes.

The ECUs 106, 108, 110 may be essentially identical or even exactly identical. For the purpose of clarity in this disclosure, only ECU 108 will be described in more detail. The ECU 108 may have a network interface 128 and encryption manager 130 corresponding to similar components in the development computer 102 or the gateway 104, for use in securely transferring information to and from the ECU 108. The ECU 108 may also have a processor 132 that is suited to the tasks of the job such as a reduced instruction set (RISK) processor targeted for real time and embedded system use, such as one from ARM Ltd. The ECU 108 may include a memory 134 used to store code and data. As above, the memory 134 may be a combination of volatile and non-volatile memories not including carrier wave or propagated media-type memories.

The memory 134 may include various elements including an operating system and utilities (not depicted) and an installer 136 and partitioned memory 138 that stores executable code and/or data used in operation of the system into which the ECU 108 is installed. The executable code may be, for example, an engine strategy, braking system algorithms, body electronics controls, transmission strategy and more. The data, if present, may include look up tables for spark timing or other settings affecting emissions, power, performance, fuel economy, etc.

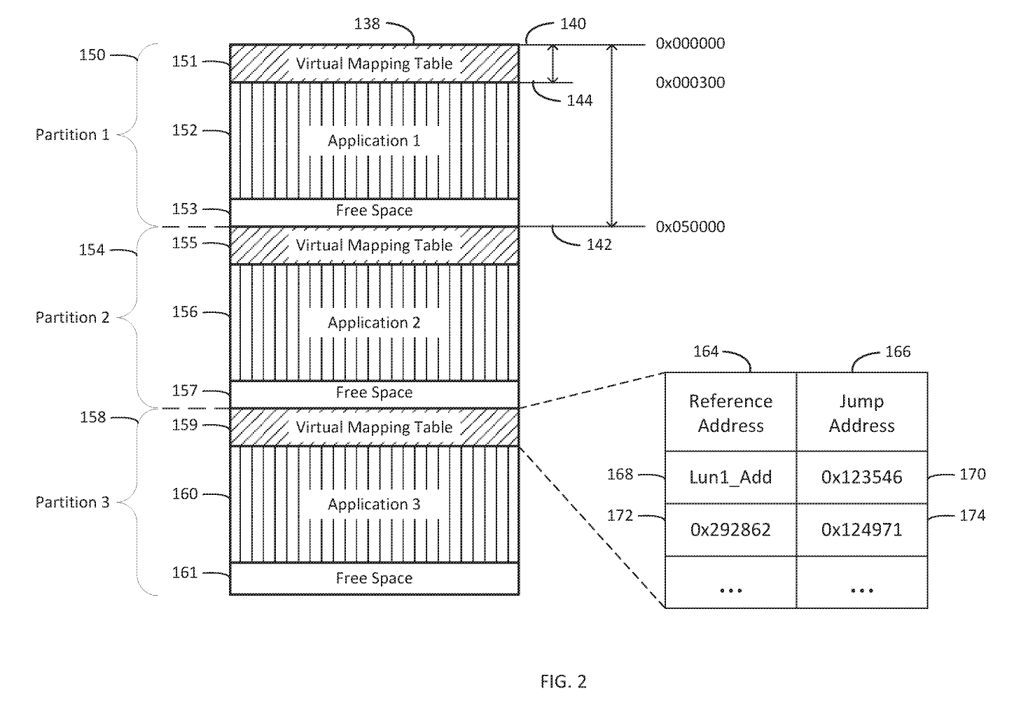

Turning to FIG. 2, the partitioned memory 138 of ECU 108 of FIG. 1 is shown in more detail. The partitioned memory 138, in this exemplary embodiment, is divided into three partitions 150, 154, and 158. Each partition may be designated or pre-assigned to have a certain memory range or address space. For example, while FIG. 2 illustrates that each partition 150, 154, 158 has an approximately equal address space, that may not be true in other embodiments, where different partitions may be significantly larger or smaller than other partitions. In this illustration, the first partition 150 has a top address 140 of 0 hexadecimal (0x000000) and a bottom address 142 of 50000 hexadecimal (0x050000). The top and bottom addresses 140, 142 define a partition address space that is non-overlapping with any other partition. Each partition 150, 154, 158 has a respective virtual mapping table 151, 155, 159. The virtual mapping tables 151, 155, 159 may be fixed in size via a table bottom address 144 and located at a predetermined memory area within its partition's address space. As illustrated, the virtual mapping tables 151, 155, 159 are located at the top of each respective memory partition 150, 154, 158, however, the virtual mapping tables 151, 155, 159 may be located at any point within its partition, as long as the location is fixed and known.

Each partition 150, 154, 158 may have a certain amount of free memory space 153, 157, 161 to allow for expansion of an application hosted in that partition. As above with the overall size of the partitions, the amount of free space allocated to each partition may vary based on overall size of the partition or the stability of the application be hosted. That is, well understood, stable functions such as an airbag controller may need less free memory space than an application that may be affected by unpredictable forces, such as changes in regulations that may affect emissions-related engine control strategy code.

As alluded to above, each partition may be pre-assigned to a different function or application related to operation of the ECU 108. These functions or routines may be owned and maintained by different entities that for reasons such as those discussed above, may not be willing or able to share source code among the entities such that a traditional static linking operation for all the code in the partitioned memory 138 could be compiled and linked at once. However, access to full source code would only address one part of a larger problem. The ECU 108 may not have enough extra memory space to allow downloading a complete copy of updated code representing the functions of all the partitions 150, 154, 158 of the memory 138 before deleting the existing copy.

A breakout of the virtual mapping table 159 illustrates representative data contained in each of the virtual mapping tables 151, 155, 159. A column 164 has reference addresses while a column 166 has jump addresses. A first reference address 168, having a virtual mnemonic reference is mapped to a jump address 170 of a physical memory location. A second reference address 172, having a virtual address is mapped to another physical address 174. The virtual mapping table 159 may be as large as needed to support the statically-linked entry points for that application. In practice, the virtual mapping table may include executable code that causes a program entering at any reference address to continue executing at the corresponding jump address, for example by setting the program counter of the processor 132 to the jump address. This functionality may be accomplished in other ways as well.

In this way, a program executing in a first partition may make a statically linked call to a memory location in a second partition hosting a program or subroutine and have the static reference successfully resolved in the second partition even though the original jump address is no longer a valid. Similarly, even calls within a particular application may use the virtual mapping table to resolve internal jumps, although unless these calls are published outside that application, it may be simpler to resolve those addresses at build time.

With reference to the build-time environment, FIG. 3 is a memory model 200 illustrating how a single application can build and link updated code for use in the system 100. A memory first memory block 202 may contain a dummy application that has only the code entry point references for the application 152 of FIG. 2. For example, the dummy application may simply have non-functional code with the exception of the call reference of the entry point located at a location matching the static address of the corresponding entry point reference address in the virtual mapping table 151 in the production application. Similarly, memory allocated to the third application 216 may have dummy code except for the entry point reference address from the virtual mapping table 159.

The second application 210, which is being updated and for which the source code is available, may be compiled in a normal fashion and then linked to the dummy applications 204 and 216 to create the static links between the second application 210 and the others. Any changes to entry points in the second application 210 may be reflected in changes to the virtual mapping table 208. The size of the free space 212 may change according to the updates being made.

The package builder 118 may be used to build an update package for use at the ECU 108 in installing the update. There are several areas of information needed by an installer 136 including, but not limited to, what application is being updated, if it is a full or an incremental update, changes to the virtual mapping table, cryptographic instructions, checksums, and confirmation requirements.

The package builder 118 may allow developers or system managers to specify these options so that the object delivered to the ECU 108 may be correctly installed. For example, in a full update, the entire memory space for an application may be overwritten with new code and a new virtual mapping table. Depending on the size of the application, this may also set the minimum necessary free memory space to accomplish an upgrade. However, an incremental update may be performed by replacing data only in the memory locations that are different between the original and the update code. For example, a limit value may be changed by simply poking the new value over the top of the old value, if the two are the same size. This is an advantageous capability when performing over-the-air (OTA) updates to code over potentially spotty wireless data networks and inside the vehicle over potentially high latency internal networks. In order to determine the code locations to be updated, a copy of the existing code may be compared with the binary output of the compiler/linker on a byte-by-byte basis to determine those memory locations where changes occur. The package builder 118 may then generate instructions for performing the individual memory location updates.

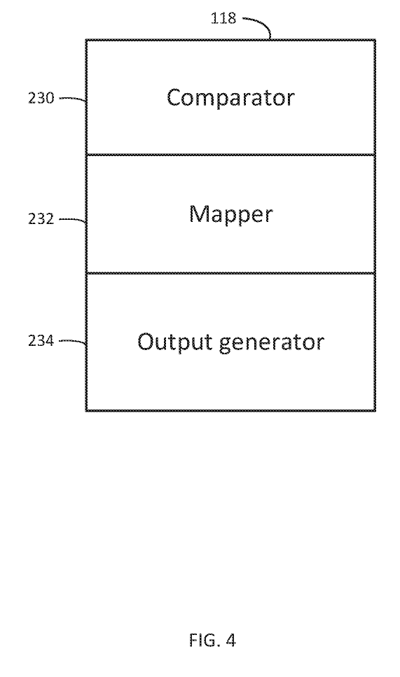

A block diagram of the package builder 118 is illustrated in FIG. 4. The package builder 118 may perform several functions associated with preparing a downloadable object for use by the ECU 108 in installing an update. A comparator 230 may be used to generate a difference file representing the changes between an existing version of code and a newly generated version. The difference file may be in the form of address/data pairs that give a location within the program and the new code for that location. In another embodiment, the address may be in the form of a range with a binary object of new code equal in size to the range. Other techniques for identifying specific areas of code to be updated may be used.

The mapper 232 may then be used to translate the location within the application to a physical address within the memory space of the ECU 108 so that the installer 136 has the necessary information, such as a reference table, to replace the code in the designated addresses. Particularly when an incremental update is being performed, the mapper 232 may also create the updated virtual mapping table 155 by correlating the static address entry points from the newly created application with the reference addresses in the virtual mapping table 155.

The package builder 118 may also include an output generator that accumulates the updates, the reference addresses, any partition indicators that are needed, metadata for checksums, instructions for confirmations, etc., into a single object that can be passed to the gateway 104 for downloading to the respective ECUs 106, 108, 110.

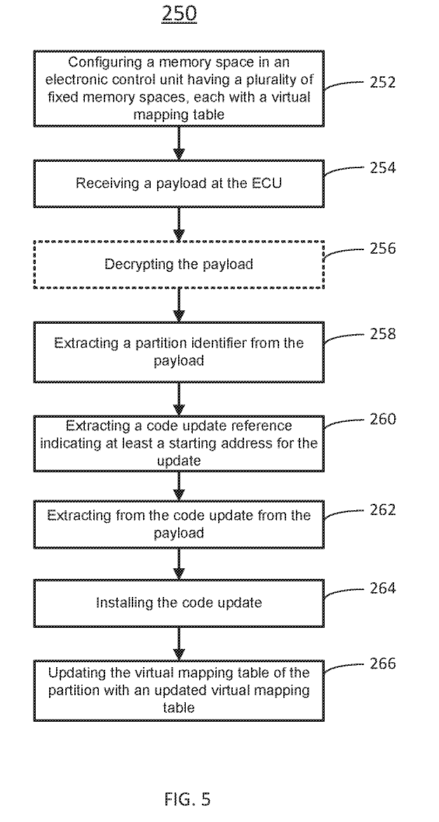

FIG. 5 is a flowchart of a method 250 of updating an electronic control unit (ECU) 108. At block 252, a memory 138 of the ECU 108 may be configured with a plurality of partitions 150, 154, 158. Each partition 150, 154, 158 may include respective virtual mapping tables 151, 155, 159. Each partition 150, 154, 158 may contain a respective application 152, 156, 160 relevant to operation of the ECU 108. The applications in each partition may be owned or maintained by different organizations. When an update to the application, e.g., application 156 in partition 154, is desired, at block 254, a payload containing update information may be received at the ECU 108 via a network connection, such as gateway 104. Optionally, at block 256, the payload may be decrypted in the instance where the payload was encrypted for reasons of security, traceability, integrity or all of these reasons. Payload encryption may also serve as an authentication tool that allows the source of the payload to be verified through access to trusted symmetric or asymmetric keys.

At block 258, a partition identifier may be extracted from the payload. The partition identifier may indicate which application 152, 156, 158 is to be updated. At block 260, a code update reference may be extracted from the payload. The code update reference may be or include a starting address for the update. Alternatively, in the case of an incremental update, one or more memory ranges may be specified that indicate where the updated code is to be installed. In embodiments where the memory space of each application is uniquely identified, the memory range may be sufficient to identify the application to be updated merely by the memory space indicated. In such a case, the separate identification of the application 156 or its partition 154 at block 258 may not be necessary.

The code update itself may be extracted from the payload at block 262. The code update may be a single object or may be individual objects that are targeted at separate memory locations with the application's memory space. After the code update is extracted, the code may be installed, for example, by the installer 136 at block 264. When required, the virtual mapping table 155 may be updated at block 266 so that the static link entry points used by other applications may be referenced to the correct execution point. The installation process may also include one or more verification steps such as calculating a checksum over the newly updated application 156 as well as the virtual mapping table 155.

The technical effect of the disclosed system and method is to both increase the performance and maintainability of code in a controller by allowing applications, routines, and data, to be accessed via statically linked code. The static linking is maintained even though updates to portions of the executable code do not have access to the full source code required for traditional compiling and linking associated with prior art embodiments. Further, smaller download packages are generated because the entire suite of all applications is not downloaded resulting in a reduced burden on both the system level delivery networks (e.g., gateway to ECU) as well as the ECU's internal networks that may use slower and less robust protocols.

Various aspects of the disclosure are reflected in the following listing:

1. An aspect updating an electronic control unit having a partitioned memory, each partition of the partitioned memory having a partition address space and a virtual mapping table, the method comprising:

receiving a payload via a network connection;

decrypting the payload;

extracting from the payload a partition identifier indicating which partition in the memory is to receive the update;

extracting from the payload a code update reference, the code update reference having at least memory starting location within the partition address space;

extracting from the payload the code update;

extracting from the payload an updated virtual mapping table;

installing the code update at the memory starting location; and

updating the virtual mapping table of the partition with the updated virtual mapping table.

2. An aspect of aspect 1, wherein receiving the payload comprises:

receiving an encrypted payload via the network connection; and

decrypting the encrypted payload.

3. An aspect of aspects 1-2, further comprising authenticating the encrypted payload.

4. An aspect of aspects 1-3, further comprising generating the encrypted payload wherein generating the encrypted payload includes:

encrypting a build package via a compilation and linking process using static references within other partitions of a model of the memory to be updated.

5. An aspect of aspects 1-4, further comprising extracting from the payload one of a memory ending location of the code update or a length of the code update.

6. An aspect of aspects 1-5, wherein the static references within the other partitions correspond to entry points of code modules or data that reside in the other partitions of the memory in the electronic control unit.

7. An aspect of aspects 1-6, wherein the code update replaces all existing code in the partition.

8. An aspect of aspects 1-7, wherein the code update replaces a portion of the existing code in the partition.

9. An aspect of aspects 1-8, wherein the code update is generated by comparing a binary version of a copy of code currently in the partition and a binary output of a compiler/linker that generates the code update.

10. An aspect of a memory for an electronic control unit comprising:

a plurality of partitions, each partition including:
a predefined first memory address corresponding to a top address of the partition;

a predefined second memory address corresponding to a bottom address of the partition, the top address and the bottom address defining a partition address space that is non-overlapping with any other partition of the plurality of partitions;

a virtual mapping table having a fixed size and located at a predetermined memory area within the partition address space; and

an application range located between the top address and the bottom address excluding the virtual mapping table, the application range storing coded data having at least one entry point referenced in the virtual mapping table.

11. An aspect of aspect 10, wherein the virtual mapping table includes one or more reference addresses published among other applications occupying other partitions of the plurality of partitions.

12. An aspect of aspects 10-11, wherein each of the one or more reference addresses has a corresponding jump address that points to a location within the partition address space.

13. An aspect of aspects 10-12, wherein a size of one of the plurality of partitions is different from at least one other of the plurality of partitions.

14. An aspect of aspects 10-13 wherein the first address of the virtual mapping table corresponds to the top address of its corresponding partition.

15. An aspect of aspects 10-14, wherein the application range includes unused memory addresses between an end of an application occupying a portion of the application range and the bottom address.

16. An aspect of a system that generates and installs incremental updates to a memory in a controller, the system comprising:

a host system including:

a first processor and first memory that execute a compiler, the compiler generating updated code from a source file and pseudo-static links to external resources;

a package builder that generates an update package including the updated code and a reference table associated with installing the updated code at the controller;

the controller including:

a network interface;

a second processor and second memory, the second memory including a plurality of predetermined partitions having fixed boundaries of non-overlapping address ranges, each partition including a virtual mapping table and code space that is non-overlapping with the virtual mapping table; and

an installer that receives the update package, installs the updated code in the code space and updates the virtual mapping table in accordance with the reference table.

17. An aspect of aspect 16, wherein the compiler uses a dummy application having the pseudo-static links for statically linking reference points for other applications installed at the controller.

18. An aspect of aspects 16-17, wherein the package builder includes a comparator that generates a difference file and a memory reference by comparing an existing code and the updated code, the difference file including a memory range covering a location for installation of the difference file.

19. An aspect of aspects 16-18, wherein the package builder includes a mapper that generates a new virtual mapping table for the updated code, the new virtual mapping table included in the update package.

20. An aspect of aspects 16-19, wherein the mapper further identifiers a partition in the controller to which the update is to be applied.

The techniques disclosed herein benefit both developers and organizations charged with maintaining operation of ECUs. Developers can work independently of other application programmers and maintain complete control of their own code. Maintenance operations benefit from faster downloads, more easily controlled and tested updates, and ultimately, better end customer satisfaction.

The figures depict preferred embodiments for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A method of updating an electronic control unit having a partitioned memory, each partition of the partitioned memory having a partition address space and a virtual mapping table, the method comprising:
receiving a payload via a network connection;
decrypting the payload;
extracting from the payload a partition identifier indicating which partition in the memory is to receive the update;
extracting from the payload a code update reference, the code update reference having at least memory starting location within the partition address space;
extracting from the payload the code update;
extracting from the payload an updated virtual mapping table;
installing the code update at the memory starting location; and
updating the virtual mapping table of the partition with the updated virtual mapping table.

2. The method of claim 1, wherein receiving the payload comprises:
receiving an encrypted payload via the network connection; and
decrypting the encrypted payload.

3. The method of claim 2, further comprising authenticating the encrypted payload.

4. The method of claim 2, further comprising generating the encrypted payload wherein generating the encrypted payload includes:
encrypting a build package generated via a compilation and linking process using static references within other partitions of a model of the memory to be updated.

5. The method of claim 1, further comprising extracting from the payload one of a memory ending location of the code update or a length of the code update.

6. The method of claim 5, wherein the static references within the other partitions correspond to entry points of code modules or data that reside in the other partitions of the memory in the electronic control unit.

7. The method of claim 1, wherein the code update replaces all existing code in the partition.

8. The method of claim 1, wherein the code update replaces a portion of the existing code in the partition.

9. The method of claim 8, wherein the code update is generated by comparing a binary version of a copy of code currently in the partition and a binary output of a compiler/linker that generates the code update.

10. A memory for an electronic control unit comprising:
a plurality of partitions, each partition including:
a predefined first memory address corresponding to a top address of the partition;
a predefined second memory address corresponding to a bottom address of the partition, the top address and the bottom address defining a partition address space that is non-overlapping with any other partition of the plurality of partitions;
a virtual mapping table having a fixed size and located at a predetermined memory area within the partition address space; and
an application range located between the top address and the bottom address excluding the virtual mapping table, the application range storing coded data having at least one entry point referenced in the virtual mapping table.

11. The memory of claim 10, wherein the virtual mapping table includes one or more reference addresses published among other applications occupying other partitions of the plurality of partitions.

12. The memory of claim 10, wherein each of the one or more reference addresses has a corresponding jump address that points to a location within the partition address space.

13. The memory of claim 10, wherein a size of one of the plurality of partitions is different from at least one other of the plurality of partitions.

14. The memory of claim 10, wherein the first address of the virtual mapping table corresponds to the top address of its corresponding partition.

15. The memory of claim 10, wherein the application range includes unused memory addresses between an end of an application occupying a portion of the application range and the bottom address.

16. A system that generates and installs incremental updates to a memory in a controller, the system comprising:
a host system including:
a first processor and first memory that execute a compiler, the compiler generating updated code from a source file and pseudo-static links to external resources;
a package builder that generates an update package including the updated code and a reference table associated with installing the updated code at the controller;
the controller including:
a network interface;
a second processor and second memory, the second memory including a plurality of predetermined partitions having fixed boundaries of non-overlapping address ranges, each partition including a virtual mapping table and code space that is non-overlapping with the virtual mapping table; and
an installer that receives the update package, installs the updated code in the code space and updates the virtual mapping table in accordance with the reference table.

17. The system of claim 16, wherein the compiler uses a dummy application having the pseudo-static links for statically linking reference points for other applications installed at the controller.

18. The system of claim 16, wherein the package builder includes a comparator that generates a difference file and a memory reference by comparing an existing code and the updated code, the difference file including a memory range covering a location for installation of the difference file.

19. The system of claim 16, wherein the package builder includes a mapper that generates a new virtual mapping table for the updated code, the new virtual mapping table included in the update package.

20. The system of claim 19, wherein the mapper further identifiers a partition in the controller to which the update is to be applied.
